(19) United States
(12) Patent Application Publication
(10) Pub. No.: US 2024/0051335 A1
(43) Pub. Date: Feb. 15, 2024

(54) IMPROVEMENTS TO FASTENING ELEMENTS OF AN EXPANDABLE AUTOMOTIVE SPARE WHEEL

(71) Applicant: Victor Resendiz Ohm, Cuautitlan Izcalli (MX)

(72) Inventor: Victor Resendiz Ohm, Cuautitlan Izcalli (MX)

(21) Appl. No.: 18/257,998

(22) PCT Filed: Nov. 25, 2021
(86) PCT No.: PCT/MX2021/050079

§ 371 Date: Jun. 16, 2023

(30) Foreign Application Priority Data
Feb. 26, 2021 (MX) MX/A/2021/002402

(51) Int. Cl. B60B 11/10

(52) U.S. Cl. CPC B60B 11/10

(57) ABSTRACT

This invention refers to an improved automotive auxiliary wheel of practical installation that does not require a mechanical jack or an additional tool to raise the car, that makes possible for the car to keep moving without having to dismount the damaged tire. It is installed on the damaged wheel by means of a female grooved hub of narrower diameter that is affixed by coupling it to a shorter male grooved hub that has a concentric inner thread placed in the car's wheel and attached with a central hexagonal screw with the help of a tightening handle. The car is moved by half a meter, and the auxiliary wheel is expanded with the lever tool with octagonal die, and the car can keep moving at low speed until it reaches a mechanical service facility. The object of this invention is to improve the expansible auxiliary wheel by making it more practical and faster to install without much effort, to solve the issue of a flat tire in short time.

This invention refers to the enhanced fastening components of an automotive expansible auxiliary wheel that helps to address the issues from changing a deflated or flat tire and keep the car going on. Installation and fastening thereof becomes quicker and practical through the use of a hexagonal fastening head screw and a male grooved hub that has a concentric inner thread.

These original fastening and locking components offer new advantages, and do not require the use of a tool to raise the bodywork of the car (hydraulic jack), or taking off the damaged wheel, thus saving time and effort.

Each of the car's wheels must have fitted the male grooved hub (11) to be used whenever any of the tires is damaged; said male grooved hub (11) has a concentric inner thread to which, together with the central hexagonal fastening head screw, the expansible auxiliary wheel is mounted and locked.

The male grooved hub (11) can be factory-installed in each of the car's rims.

After the expansible auxiliary wheel is mounted in the grooved hub (11), the central hexagonal fastening screw is (15) tightened with the tightening handle (16) built to the individual specifications of the screw's hexagonal head, by using side A.

The driver moves the car forwards or backwards between 50 cm and 100 cm and places a triangular stop (28) at the required distance, thus limiting the movement of the car, and by turning the expansible auxiliary wheel the damaged wheel is lifted.

Then the semicircular arm (5) of the expansible auxiliary wheel is expanded by turning the cam hub (3) with the octagon-shaped tightening handle (16) by using size B.

By expanding the semicircular arm (5) the circumference of the expansible auxiliary wheel is completed, and the cam lock (17) is triggered to prevent the contraction thereof and make possible for the car to move.

The new design of the coupling and fastening components, like the male grooved hub with concentric inner thread (11) and the central hexagonal fastening head screw (15) have the following advantages: first, it makes possible to reduce the projection of the male grooved hub by deleting the length of the outer thread of the former design. Second: a mechanical protection is now provided to the inner thread, thus preventing any malfunctions thereof that prevents the coupling between the thread of the screw and the concentric inner thread. Fourth(sic), makes possible to reduce the diameter of the male grooved hub and the female grooved hub of the expansible auxiliary wheel, thus reducing the costs of materials and the processing times for the machining of both the thread and the concentric inner thread, which translates to lower manufacturing costs.

### BACKGROUND OF THE INVENTION

The former products available were canned chemicals, silicon sprays, smaller auxiliary wheels with capable of lower performance and limited mileage.

In Mexican patent No. 360884, the design of the fastening components of the expansible auxiliary wheel differs from the improvement set forth herein, because patent No. 360884 requires a grooved hub of at least twice the length, which is equal to the sum of the length of the grooved section plus the length of the outer thread in which a fastening nut is coupled; on the other hand, the grooved hub of patent No. 360884 has a bigger outer diameter, which entails higher costs in materials and manufacturing time, other disadvantage thereof is that the thread is left exposed and a larger grooved hub is heavier.

### BRIEF DESCRIPTION OF THE DRAWINGS

To better understand the working principles of the expansible auxiliary wheel, hereto a brief description of the figures is attached.

FIG. 1. —Back view of the expansible auxiliary wheel with the female grooved hub of reduced diameter, that shows the activation mechanism in the working position for an effective installation thereof.

FIG. 2. —Back view of the expansible auxiliary wheel with the female grooved hub of reduced diameter, that shows the activation mechanism in a retracted state for installation thereof when the wheel of the car is deflated or flat.

FIG. 3. —Shows a cross section of the expansible auxiliary wheel with grooved hub of reduced diameter when installed and fastened in the car's tire.

FIG. 4. —Shows the male grooved hub of reduced diameter with an inner concentric thread with the hexagonal head screw that the car must have fitted in each of its wheels.

### DETAILED DESCRIPTION OF THE INVENTION

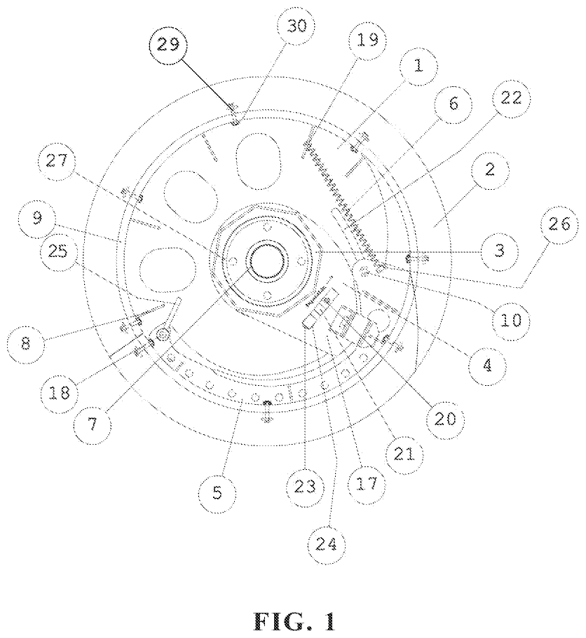

FIG. 1 illustrates the expansible auxiliary wheel, which consists of a semicircular plate (1) with a semicircular arm (5) that expands or contracts for the installation thereof. This is made possible by a contraction spring (6) that has a point of support. The spring is coupled to a first fastening method (19) and is coupled in the other end to the semicircular arm (5). This semicircular arm is supported by a fastening bolt (18) that works as an axis and is placed close to the metallic hoop (9).

The auxiliary wheel is expanded when the hub is turned counter-clockwise. This hub consists of a cam hub (3) that has a cam-shaped welded lever (4). The semicircular arm is pushed (5) and a circumference is formed.

The semicircular arm (5) has in its right end a bolt (10) that moves in the rim through a slot (22) that works as a guide. It is also fitted with a cam lock (17) to prevent it from contracting when the auxiliary wheel is receiving the load of the car.

Its perimeter is fitted with a metallic hoop (9) that fastens a rubber belt (2) to have traction and absorb the vibrations from the floor. The metallic hoop (9) and the rubber belt (2) consist of 2 parts; one is the rim and other is the semicircular arm (5), the metallic hoop and the rubber belt are fastened with each other by 8 anchor-shaped screws (29) and nuts (30). In its central portion there is a female grooved hub (7) of reduced diameter for the affixing thereof; this is coupled with the male grooved hub that has a concentric inner thread (11) in the car's wheel and that it is locked with a central hexagonal screw (15) with the help of the tightening handle (16).

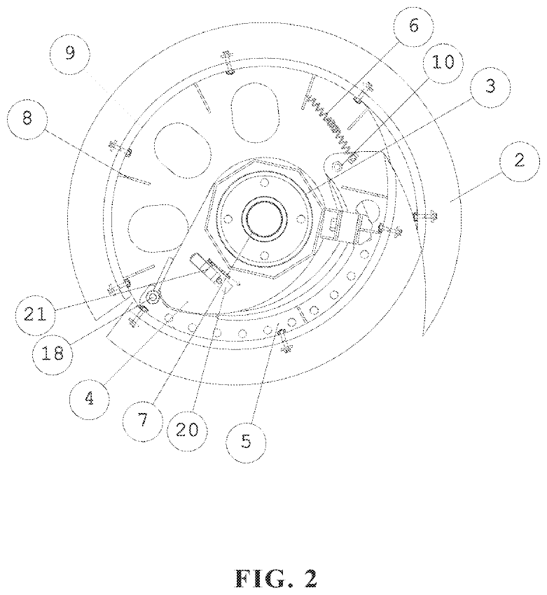

FIG. 2) illustrates the contraction of the auxiliary wheel for the installation thereof. The cam hub (3) is in the opposite state without exerting pressure on the arm (5) contracted by the contraction spring (6). To contract the wheel the cam lock (17) is pressed to deactivate the wheel, and the cam hub (3) with cam (4) is turned clockwise until its limit (25) to contract the auxiliary wheel.

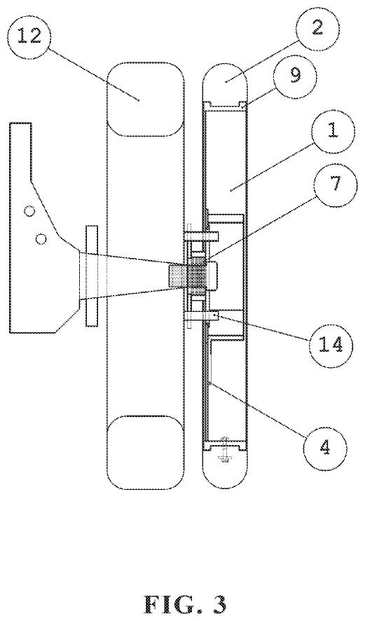

FIG. 3) illustrates a cross section of the position of the installed and locked expansible auxiliary wheel. Here, the installation thereof over the car's tire can be observed, mounted in the hub with the male grooved hub with inner thread (11) and tightened with a central hexagonal screw (15) helped by the tightening handle (16).

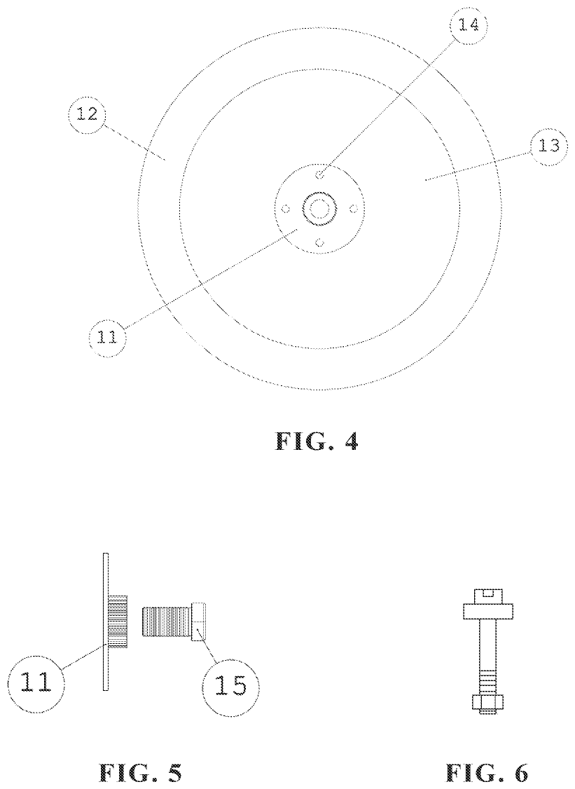

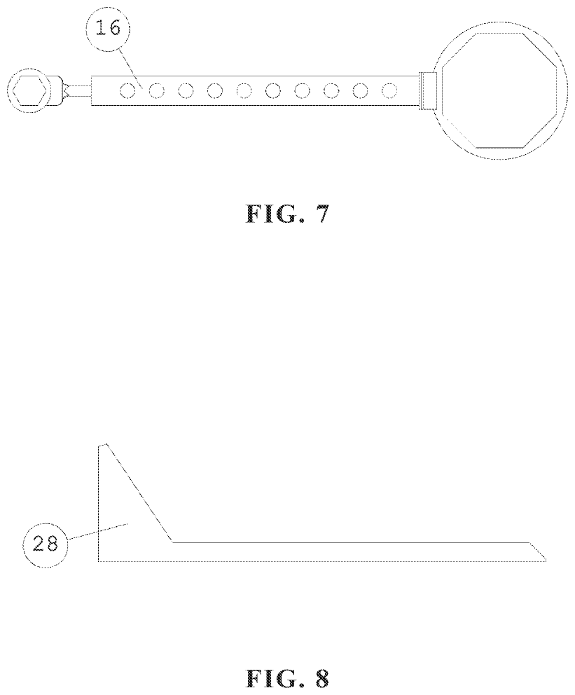

FIG. 4) illustrates the male grooved hub of reduced diameter with inner thread (11).

FIG. 5) illustrates the central hexagonal screw (15) and the male grooved hub of reduced diameter with inner thread (11) that the car must have fitted in each of its wheels.

FIG. 6) illustrates the anchor-shaped screw (29) with nut (30).

FIG. 7) illustrates the handle that uses side A to tighten the central hexagonal screw and side B to activate the expansible auxiliary wheel.

FIG. 8 illustrates the triangular stop (28).

This expansible auxiliary wheel is tailor made to the conditions of the car and the diameter as per the car's manufacturer.

Its effectiveness lies in its use for short, low speed routes. It is a practical solution for the problem posed by a deflated or destroyed tire, to keep moving towards the destination.

This expansible auxiliary wheel does not take more space in the trunk than a conventional auxiliary wheel would.

### PREFERRED MODE OF THE INVENTION

Expansible auxiliary wheel comprising a semicircular plate (1) and a semicircular arm (5), connected for pivoting motion in one of its ends, by means of a coupling bolt (18), which set out a resting state where the semicircular arm (5) is in a retracted position over the body of the semicircular plate (1), and a working state where the semicircular arm (5) is in an expanded position and forming, together with the semicircular plate, a complete rim where both the semicircular plate and the semicircular arm's curved periphery is covered by a metallic hoop (9) to produce a greater load resistance, and a rubber belt (2) is attached over the outer part of said metallic hoop, which creates traction and absorbs vibration while at work; the semicircular plate (1) has a hole located in the center of the rim formed by the semicircular plate (1) and the semicircular arm (5), which has a female grooved hub (7) fitted for the installation of the semicircular plate (1); over said female grooved hub (7) a cam hub (3) with a predefined form is placed, as the base of a cam (4); said cam hub (3) is connected to the semicircular plate (1) by a fastening hoop (27) which makes possible for the cam hub (3) to turn unrestricted, and also makes possible for the cam to rest in a horizontal position, between the inner periphery of the semicircular arm (5) and a stop (25) placed over the body of the semicircular plate (1), placed near the ends connected by the coupling bolt (18), taking as a reference a vertical axis that goes through the center of the semicircular plate (1), located on the opposite side of the stop (25) there is a first fastening method (19) to which one end of a contraction spring (6) is affixed, the other end of said contraction spring (6) is affixed to a second fastening method (26) located in the free end of the semicircular arm (5), with the purpose of keeping said semicircular arm (5) in a horizontal position, when the wheel is at rest; taking as a reference the vertical axis that goes through the center of the semicircular plate (1), and located in the opposite side of the coupling bolt (18), over the body of the semicircular plate (1) there is a bolt (10), that functions as a slot (22) guide; said slot is placed vertically in the free end of the semicircular arm (5), underneath the second fastening method (26), and the function of which is to guide and limit the movement of the semicircular arm (5) during the transition of the auxiliary wheel from the resting to the working state. When the cam hub (3) is turned counter-clockwise, the cam (4) pushes the semicircular arm (5) outwards, going from the resting to the working state, and said semicircular plate (1) and semicircular arm (5) form a complete rim; in the distal end of the cam (4) there is a cam lock (17) that prevents said cam (4) from moving.

Where the female grooved hub (7) has a narrower diameter and for fixation thereof is coupled to a male grooved hub with concentric inner thread (11) located in the car's wheel and locked with a central hexagonal screw (15) with the help of a tightening handle (16).

Where the metallic hoop (9) and the rubber belt (2) are fastened to each other through anchor-shaped screws (29) and nuts (30).

Where said semicircular plate has reinforcements (8) in the shape of triangular ribbing placed at the same distance throughout the inner periphery of said semicircular plate and that extends towards the center thereof.

Where the semicircular plate (1) and the semicircular arm (5) are made from metal.

Where the predefined shape of the cam hub is octagonal.

### DESCRIPTION OF THE COMPONENTS ILLUSTRATED IN THE FIGURES

1. Semicircular plate
2. Rubber belt
3. Cam hub
4. Cam
5. Semicircular arm
6. Contraction spring
7. Female grooved hub of narrower diameter
8. Reinforcements
9. Metallic hoop
10. Bolt
11. Male grooved hub with concentric inner thread
12. Tire
13. Car's rim
14. Set screws of the fastening nut
15. Central hexagonal screw
16. Tightening handle
17. Cam lock
18. Coupling bolt
19. First fastening method
20. Safe bolt
21. Base of the safe bolt
22. Slot
23. Spring that pushes the lock
24. Lever of the lock
25. Stop
26. Second fastening method
27. Fastening hoop
28. Triangular stop
29. Anchor screws
30. Nuts of the anchor screw

1. An expansible auxiliary wheel comprising:
a semicircular plate (1) and one semicircular arm (5) connected for pivoting motion in one of their ends, through a coupling bolt (18), which determine a resting state in which the semicircular arm (5) is in a retracted position over the body of the semicircular plate (1), and a working state where the semicircular arm (5) is in an expanded position and forms, together with the semicircular plate (1) a full rim; the curved perimeter of both the semicircular plate and the semicircular arm is covered by a metallic hoop (9) to produce a higher load resistance, and a rubber belt (2) is attached over the outer part of said metallic hoop, which creates traction and absorb vibrations while at work; the semicircular plate (1) has a hole placed in the center of the rim formed by the semicircular plate (1) and the semicircular arm (5), which has a female grooved hub (7) adapted for the installation of the semicircular plate (1); over said female grooved hub (7) a cam hub (3) with a predefined form is placed as the base of a cam (4); said cam hub (3) is connected to the semicircular plate (1) through a fastening hoop (27) which allows the cam hub (3) to turn unrestricted, and also allows the cam to rest in a horizontal position in said resting state, between the inner periphery of the semicircular arm (5) and a stop (25) placed over the body of the semicircular plate (1), placed next to the ends connected by the coupling bolt (18), taking as a reference a vertical axis that goes through the hub of the semicircular plate (1); located on the opposite site of the stop (25) there is a first fastening method (19) to which one end of a contraction spring (6) is affixed; the other end of said contraction spring (6) is affixed to a second fastening method (26) located on the free end of the semicircular arm (5), to keep said semicircular arm (5) in a horizontal position, when the wheel is at rest; taking as a reference the vertical axis that goes through the hub of the semicircular plate (1), and located in the opposite side of the coupling bolt (18), over the body of the semicircular plate (1) there is a bolt (10) that functions as a slot (22) guide; said slot is placed vertically in the free end of the semicircular arm (5), underneath the second fastening method (26), and the function of which is to guide and limit the movement of the semicircular arm (5), for the transition of the auxiliary wheel from the resting to the working state. When the cam hub (3) is turned counter-clockwise, the cam (4) pushes the semicircular arm (5) outwards, going from the resting to the working state; said semicircular plate (1) and semicircular arm (5) form a complete rim; in the distal end of the cam (4) there is a cam lock (17) that prevents said cam (4) from moving, and is characterized by a female grooved hub (7) of narrower diameter that for fixation thereof is coupled to a male grooved hub that has an inner concentric thread (11) placed in the car's wheel and is affixed with a central hexagonal screw (15) with the help of a tightening handle (16), where the metallic hoop (9) and the rubber belt (2) are fastened to each other through anchor-shaped screws (29) and nuts (30).

2. The expansible auxiliary wheel in accordance with claim 1, characterized by said semicircular plate having reinforcements (8) in the shape of triangular ribbing placed equidistantly throughout the inner periphery of said semicircular plate and that extends towards the center thereof.

3. The expansible auxiliary wheel in accordance with claim 1, characterized by the semicircular plate (1) and the semicircular arm (5) being made from metal.

4. The expansible auxiliary wheel in accordance with claim 1, characterized by having an octagonal predefined shape for the cam hub.

5. The expansible auxiliary wheel in accordance with claim 1, characterized by a triangular stop (28) that prevents the car from moving, and that is placed at a distance between 50 and 100 cm before turning the cam hub (3) that pushes the semicircular arm (5) outwards, going from the resting to the working state.
